(19) United States
(12) Patent Application Publication
(10) Pub. No.: US 2007/0198525 A1
(43) Pub. Date: Aug. 23, 2007

(54) Computer system with update-based quarantine

(75) Inventors: Arindam Chatterjee, Issaquah, WA (US); Bashar J. Kachachi, Kirkland, WA (US); Bruce Leban, Redmond, WA (US); Calvin Choon-Hwan Choe, Redmond, WA (US); Charles G. Jeffries, Sammamish, WA (US); Jeffrey E. Shipman, Redmond, WA (US); Lakshmanan Venkitaraman, Redmond, WA (US); Marc Shepard, Bellevue, WA (US); Sachin C. Sheth, Bothell, WA (US); Shankar Seal, Bellevue, WA (US); Yang Gao, Issaquah, WA (US); Patrick J. Stratton, Redmond, WA (US); Michael D. Lee, Bellevue, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/353,872

(22) Filed: Feb. 13, 2006

(51) Int. Cl. G06F 17/30

(52) U.S. Cl. 707/10

(57) ABSTRACT

A managed network with a quarantine enforcement policy based on the status of installed updates for software on each client seeking access to the managed network. To determine whether a client requesting access has up-to-date software, an access server may communicate directly with an update server to determine the update status of the client requesting access. Information from the update server allows the update server to determine which update the client requesting access is missing. The access server may also receive an indication of the severity of the updates missing from the client requesting access. The access server may use the severity information to apply a quarantine enforcement policy, thereby avoiding the need for either the client or access server to be programmed to identify specific software updates that must be installed for a client to comply with a quarantine enforcement policy. To reduce network congestion and delays seeking access to the network, the quarantine enforcement policy includes a deadline by which updates must be installed. Establishing a deadline allows a grace period during which clients may download new updates and avoids network congestion from multiple clients downloading updates simultaneously.

### BACKGROUND

Maintaining the integrity of computer systems has become an increasingly important function as the role of computer systems in all aspects of modem life has expanded. Simultaneously, the threats to computer systems have grown. Networked computer systems are particularly vulnerable to threats posed by “viruses,” “spyware” and “hackers” bent on stealing information or disrupting operation of the computer system.

One approach to increasing the integrity of networked computer systems involves the use of protective software. Each client to connect to the network is equipped with software that can detect and thwart threats to the networked computer system. Firewalls, antivirus software and antispyware software are examples of protective software that is widely used on network clients. A drawback of such protective software is that, to be fully effective, the software must be enabled and updated to address new threats as the threats are created.

To facilitate easy updates, protective software often includes data files holding definitions of threats that the software can detect or prevent. These data files may be easily updated, such as by downloading from a server new files to describe new threats. Nonetheless, the operator of each client connected to a network must take action to keep the client up-to-date. An operator may take action explicitly, such as by periodically downloading new data files. Alternatively, the operator may take action by configuring the protective software to automatically download new data files. Sometimes, the operator does not properly update, operate or configure protective software, leaving the computer system open to vulnerabilities.

Vulnerabilities caused by improper use of protective software are sometimes addressed through a “quarantine” approach. Clients seeking to access a network may be denied access or “quarantined,” if they do not have the most up-to-date protective software. A quarantined client may be given limited access to the network, sufficient to allow the computer to be “remediated,” such as downloading updates to the protective software from a server.

### SUMMARY OF INVENTION

The invention relates to a computer system that may quarantine clients seeking access to a network based at least in part on whether the client includes up-to-date software.

In one aspect, the invention relates to a method of operating a computer system containing a service that can provide access to software updates to clients in the network. As clients seek access to the network, a service can receive a status indication about the client. A decision to grant network access can then be based, at least in part, on the update status of the client. In this way, decisions to provide network access may be based on information about the status of the client beyond what can be gleaned either by software agents executing on the client or by software agents executing within the service alone.

In another aspect, the invention relates to a method of operating a computer system in which software updates are categorized. When a client seeking access to the network is missing an update, a decision to quarantine the client is based, at least in part, on the category of the missing update. For example, software updates may be categorized as critical, important or low priority. By making a quarantine decision based on the category, the network administrator may specify a quarantine enforcement policy without detailed knowledge of the nature of updates available.

In another aspect, the invention relates to a method of operating a computer system in which enforcement of quarantine policies relating to updates for client software is based, at least in part, on the length of time that has passed since a client has downloaded an update. By delaying the time that all clients missing updates are forced to remediate, load on servers providing updates is spread over time. Additionally, a network administrator can balance urgency of applying an update against the inconvenience to users of being forced to apply a patch at a potentially inconvenient time by setting a short grace period to ensure quick application of urgent updates or a long grace period to lessen inconvenience.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a networked computer system according to an embodiment of the invention;

FIG. 2 is a software block diagram according to an embodiment of the invention;

FIG. 3 is a sketch illustrating a statement of health transmitted by a client computer according to an embodiment of the invention;

FIG. 4 is a flow chart illustrating a process of operating a computer system according to an embodiment of the invention;

FIG. 5 is a sketch of a graphical user interface that may be used to configure a computer system according to an embodiment of the invention; and

FIG. 6 is a software block diagram according to an alternative embodiment of the invention.

### DETAILED DESCRIPTION

It would be desirable to increase the integrity of a networked computer system by increasing the ability of the system to detect clients that pose a security risk to the network because they do not contain or use the most up-to-date software. However, any increase in the level of protection should not unreasonably burden the network or network users and should be easily administered. As described below, an improved quarantine management system is provided to administer a quarantine enforcement policy based, at least in part, on the update status of a client seeking access to the network.

As used herein, a quarantine enforcement policy refers to an embodiment of the logic used to determine whether a client may be given access to a network based on the status of software on the client (also referred to as client “health”). The policy may be stored in a data structure as a set of criteria or rules that must be satisfied for a client to be granted network access. However, any suitable method of defining a quarantine enforcement policy may be used. Further, a quarantine enforcement policy may be just one part of a larger access control policy. Accordingly, reference to a grant or denial of network access based on the quarantine enforcement policy does not preclude the possibility that the client will be denied or granted access for other reasons.

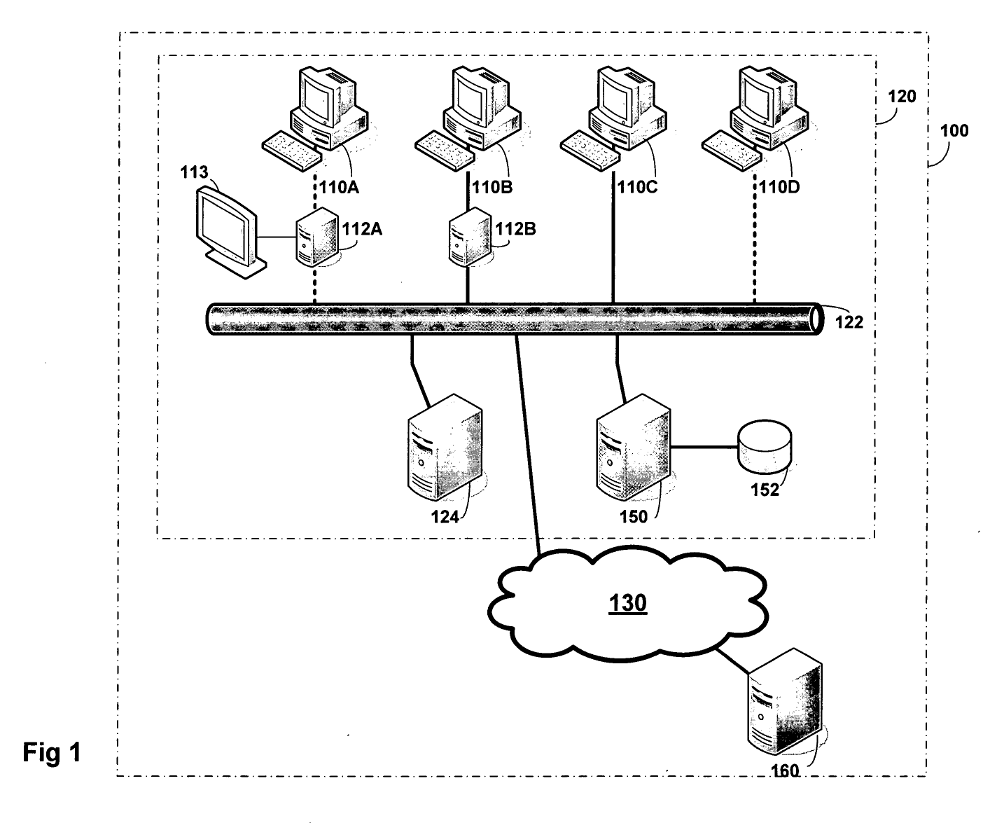

FIG. 1 shows a sketch of a computer system 100, which may be constructed from devices as are used in conventional computer systems. However, computer system 100 differs from a conventional computer system in that devices within computer system 100 are programmed to implement an improved quarantine management system.

Computer system 100 includes a managed network 120. In this example, managed network 120 may be a network within a company or enterprise. Alternatively, managed network 120 may be a domain or other portion of a larger network. Managed network 120 is managed by an individual or entity that provides access policies for the network. A person or entity who provides these network management functions is referred to generally as “a network administrator.” In a networked computer system, there may be multiple people or entities providing network management functions, any or all of which may be generally referred to as a network administrator.

As is shown in FIG. 1, managed network 120 includes network devices such as server 124 and clients 110A, 110B, 110C and 110D. Here a wide area network (WAN) 122 is shown interconnecting the network devices. This configuration is shown for simplicity of illustration. A managed network may contain more devices than illustrated in FIG. 1. Likewise, a single WAN 122 is shown, but a managed network may contain different or additional interconnection architectures.

The example of FIG. 1 shows that clients 110B and 110C have already been given access to managed network 120. Network access is represented in FIG. 1 by solid lines connecting clients 110B and 110C to WAN 122. In contrast, clients 110A and 110D, though physically connected to the network, are shown in FIG. 1 in an operating state in which the clients have not been given access to managed network 120.

Managed network 120 may employ one or more methods to grant or deny access to clients. Clients may, for example, connect to managed network 120 through an access control server. Access control servers 112A and 112B may be dialup servers or wireless access points, for example, a “RADIUS” servers, “IAS” servers or a level 2 access control servers, or any other suitable servers or devices that may selectively grant or deny access to managed network 120.

Alternatively, a client may connect to managed network 120 without making a connection through an access control server. In this configuration, network software running on devices within the network may control access to network devices. FIG. 1 illustrates that clients 110C and 110D are connected directly to WAN 122.

Though not expressly shown in FIG. 1, a client may be connected to WAN 122 by a switching device, such as a router, switch, hub, bridge, gateway or any other suitable device. One or more such switching devices may be employed, regardless of whether a client is connected to WAN 122 through an access server or is connected directly to WAN 122.

FIG. 1 shows client 110A seeking to connect to managed network 120 through access server 112A. Though client 110A is shown physically connected to the network, client 110A has not yet been granted access to resources of managed network 120. The dotted line shown connecting client 110A to managed network 120 represents that client 110A has not been given access. Similarly, FIG. 1 shows client 110D seeking access to managed network 120.

Regardless of the specific mechanism used to control access to managed network 120, a client seeking access to managed network 120 may be granted or denied access in accordance with a quarantine enforcement policy. Servers 112A and 112B are programmed to grant or deny network access in accordance with a quarantine enforcement policy. As a client, such as client 110A, seeks access to managed network 120, server 112A enforces access restrictions on client 110A. When a client that is connected directly to WAN 122, such as client 110D, desires access to, managed network 120, the network software enforces access restrictions on client 110D.

Access can be controlled in a variety of ways, including configuring the components of WAN 122 such that attempted communications between a quarantined client and other network devices are discarded by the WAN. Alternatively, a network layer of a quarantined client may be configured so that it does not see any other computers on the network. Or IPSEC may be used to prevent a quarantined client from communicating with other clients. Or, any suitable means or combination of means may be used to control access to managed network 120, thereby placing a client in quarantine.

WAN 122 can be configured to alternatively or additionally allow clients 110A or 110D to connect to networks or devices outside of managed network 120 even if denied access to managed network 120 (i.e., the client is “quarantined”). In the embodiment illustrated in FIG. 1, WAN 122 may allow client 110A to access the Internet 130. Through Internet 130, client 110A may reach devices such as server 160. Server 160 may provide a quarantined client with information, up-dates or other software needed to become compliant with a quarantine enforcement policy. In this way, a non-compliant client may remediate itself to qualify for access to managed network 120.

In some embodiments, information needed to remediate a client may be available within managed network 120. In such embodiments, a quarantined client may be allowed sufficient access to devices within managed network 120 to obtain remediation information even though denied access to other network devices. In the embodiment of FIG. 1, server 150 acts as an update server and a quarantined client may be allowed to access update server 150 to remediate itself.

In the embodiment illustrated, server 150 is coupled to database 152. Database 152 may contain software updates for software executing on client 110A. Updates stored in database 152 may include updates to antivirus software, antispyware software or other software that may alter the “health” of client 110A. If client 110A is denied access to managed network 120 because its protective software is out of date, client 110A may nonetheless connect to update server 150 to obtain updates to its protective software.

Database 152 may contain software updates in the form of files that may be downloaded to operate with protective software on client 110A. For example, data files that contain virus signatures or other threat signatures may be downloaded for use in conjunction with antivirus or antispyware programs. Alternatively, database 152 may contain patches for software executing on client 110A, including operating system software or application software. A patch is a representation of updated software, usually in compressed form and often created by encoding differences between one version of a software program and a later version. Each “update” may contain only incremental changes from a prior version of protective software or data used by that protective software or may contain a complete copy of the software or data in its most current form, or may contain information in any suitable form. However, any suitable representation of a patch may be used.

Database 152 also may contain updates for operating system or other general purpose software executing on client 110A. Though operating system software is not generally regarded as protective software, the status of operating system software may have a large impact on the health of client computer 110A. For example, hackers may try to discover and exploit weaknesses (“vulnerabilities”) in operating system software. As vulnerabilities in general purpose software are identified, software vendors may respond by issuing patches that modify the software to fix those vulnerabilities. Therefore, the extent to which a client has installed patches, particularly patches directed to fixing vulnerabilities, may be regarded as an indication of the health of a client. In some embodiments, access servers 112A and 112B are programmed to implement a quarantine enforcement policy in which access to managed network 120 is granted or denied based, at least in part, on whether patches directed to vulnerabilities in general purpose software have been installed on the client.

In some embodiments, client 110A may access software updates from update server 150 in response to commands from a user operating client 110A. Alternatively, client 110A may be programmed to automatically access update server 150 in response to being denied access to managed network 120. In this way, a client that lacks sufficient health to be admitted to managed network 120 may nonetheless be “remediated” so that it qualifies for access to managed network 120.

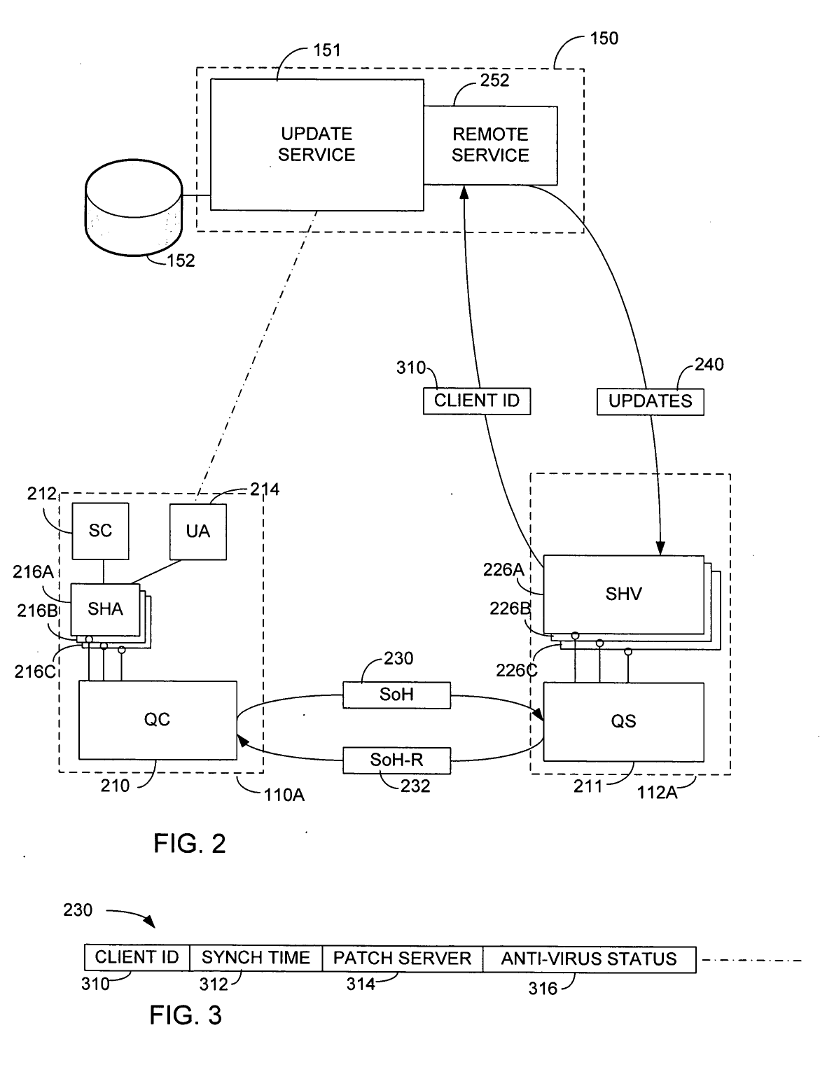

Turning to FIG. 2, a portion of the software within computer system 100 is illustrated. FIG. 2 shows that software in client computer 110, access server 112A and update server 150 includes a plurality of components. Each component may be implemented as multiple computer-executable instructions stored in a computer-readable medium accessible to a computing device. The components may be implemented in any suitable language and may run on any suitable computing device. Conventional programming techniques may be used to implement the functions described herein.

One of the software components is update agent 214, which accesses update server 150 to obtain and install patches within client 110A. Update agent 214 may, for example, periodically prompt a user of client 110A for permission to access update server 150 to check for updates. Alternatively, update agent 214 may operate in an automatic fashion, periodically obtaining updates without requiring a user of client 110A to take any action to initiate the update process.

Update agent 214 may use any suitable method to obtain patches from update server 150. In some embodiments, update server 150 may track each client for which it provides updates. Accordingly, each client receiving updates from update server 150 may have a code or other identifier by which client 110A may identify itself to update server 150. In this way, update server 150 may determine which patches need to be provided to client 110A when update agent 214 accesses update server 150.

In some embodiments, each client that obtains updates from update server 150 may use a unique identifier and update server 150 may store, in conjunction with each unique identifier, a record of updates provided to the client. However, any suitable way may be used to allow update server 150 to identify patches or other updates that have not been provided to the client. For example, a client identifier may be generated from codes identifying patches that have been installed. Regardless of the specific mechanism by which update server 150 identifies patches that have not been provided to client 110A, when update agent 214 accesses update server 150 requesting an update, server 150 determines patches required by client 110A and provides those patches to update agent 214. Update agent 214 then installs the updates on client 110A.

Another type of component illustrated in FIG. 2 are system health agents (SHAs). Client computer 110A includes multiple SHAs, here illustrated as SHAs 216A, 216B and 216C. In this example, each SHA is a software component that can determine the status of software operating on client 110A. For example, an SHA may be provided to determine status of antivirus software. A second SHA may be provided to determine the status of firewall software. Further SHAs may be provided to determine the status of antispyware software or any other protective software. As used herein, the “status” of protective software may refer to any operating condition useful in determining the health of client 110A. For example, the status of antivirus software may be based on whether the software is enabled or whether it has been updated with new virus definitions within some predetermined interval or whether specific definitions have been updated.

Further, an SHA may be provided to monitor the status of software updates installed in client computer 110A. In some embodiments, an SHA may be able to determine the patches that have been installed to software (not shown) executing within client 110A. For example, the WINDOWS® brand operating system includes a registry entry recording each patch installed to the operating system. An SHA may be constructed using known programming techniques to ascertain by reading this registry, or in any other suitable way, the status of patches installed or not installed on a client.

In some embodiments, SHAs are provided by software vendors, possibly in conjunction with specific versions of protective software. For example, a vendor providing antivirus software may provide an SHA that can determine the status of that antivirus software.

The embodiment illustrated in FIG. 2 shows a security center (SC) component 212. Software operating on client 110A may provide status information to SC 212 and an SHA may determine software status by accessing SC 212. However, any suitable means to obtain status information may be used.

Client 110A also includes a quarantine client agent (QC) 210. In the embodiment illustrated, QC 210 manages interactions with access server 112A when client 110A is seeking access to a network. In the illustrated embodiment, a request for access to a managed network includes a transmission from QC 210 to access server 112A. In the illustrated embodiment, the request for access includes a statement of health 230. The statement of health 230 provides status information gathered by QC 210. In the illustrated embodiment, this status information is gathered from SHAs 216A . . . 216C, but any other suitable way may be used.

Server 112A includes a corresponding quarantine server agent (QS) 211. QS 211 receives the statement of health and manages the process of determining whether client 110A has a health sufficient to warrant access to managed network 120. The determination of whether client 110A qualifies for network access is made in accordance with a quarantine enforcement policy provided by a network administrator. QS 211 may pass information to access control software within server 112A, indicating whether client 110A should be given access to managed network 120. Conventional access control software may grant or deny such access in accordance with the information provided by QS 211. Alternatively or additionally, QS 211 may send back a response to client 110A, indicating that client 110A is “quarantined.”

In determining whether client 110A qualifies for access to managed network 120, QS 211 may access one or more system of health validators (SHV) 226A, 226B, 226C. Each SHV compares some aspect of statement of health 230 to a portion of the quarantine enforcement policy to determine whether client 110A meets that aspect of the quarantine enforcement policy.

Access server 112A may contain an SHV corresponding to each SHA that may appear in any client seeking access to managed network 120. Though, there is no requirement for a one-to-one relationship between the SHAs and SHVs because an SHV may support multiple SHAs, and vice versa. If multiple SHVs are present, QS 211 will aggregate the outputs of each to determine an overall quarantine decision for a client seeking access to a managed network. As with each of the SHAs, each SHV may be provided by a software vendor that provided protective software. In the example of FIG. 2, SHV 226A may represent a component that processes a portion of the statement of health defining the patch status of the operating system of client 110A which may be generated by a corresponding SHA 216A.

FIG. 3 shows portions of statement of health 230 containing status information used by SHV 226A. In the illustrated embodiment, statement of health 230 includes a client identification field 310, a synchronization time field 312, a patch server identification field 314, an antivirus status field 316 and may contain other fields identifying health, which are not shown for simplicity. Patch server identification field 314 contains an identifier for an update server used by client 110A to obtain software patches. In this example, patch server identification field 314 contains the URL for update server 150.

Synchronization time field 312 contains a time code indicating the last time at which client 110A downloaded a catalogue of updates available from update server 150. This catalogue may be used to determine the status of client 110A.

Client identifier field 310 contains an identification code used by client 110A to identify itself to update server 150. In the described embodiment, update server 150 tracks each client to which it provides updates by a client identifier.

By providing the client identifier to SHV 226A, SHV 226A may access information from update server 150 concerning the update status of the client. Though status information is traditionally generated by SHAs executing on the client, patches may not be released on a predictable schedule and an SHA may not be able to determine whether all available patches have been applied to a client. Rather, an SHA may report status by indicating which patches have been installed or may report status by indicating the time at which the client last downloaded updates from an update server. Therefore, in addition to simply comparing the statement of health to a policy, SHV 226A may obtain additional information about available patches from the update server identified in patch server field 314.

Upon receipt of statement of health 230, QS 211 provides SHV 226A those portions of statement of health 230 relevant to the status of patches within client 110A. In this example, SHV 226A receives the information from client identification field 310, synchronization time field 312, and patch server identification field 314.

SHV 226A uses the information from patch server identifier field 314 to access update server 150. In the pictured embodiment, SHV 226 connects to update server 150 through a remote service 252, which may be a web service. Remote service 252 may be implemented with conventional technology to provide a mechanism for SHV 226A to obtain information from update server 150. The specific implementation may depend on the overall system architecture and may even be omitted in some embodiments. For example, if the update server is implemented on the same physical computer as SHV 226A, then the update server may be contacted directly without use of a remote service.

SHV 226A does not, itself, need updates from server 150. Rather, SHV 226A may obtain from update server 150 information concerning the update status of client 110A. In the example where update server 150 provides patches for the operating system of client 110A, SHV 226A receives through remote service 252 information about available patches that have not been applied to client 110A.

When a client sends a statement of health as part of a request for network access, SHV 226A communicates through remote service 252 with update server 150. Part of the communication may involve transmission of the information from client identifier field 310 of statement of health 230 that identifies a specific client about which information is requested. Other information, including information from synch time field 312 may also be transmitted.

Remote service 252 accesses update server 150 to obtain information on updates available through update server 150 that have not been installed in client 110A. Information on available updates is provided in a message containing update information 240 passed from remote service 252 to SHV 226.

SHV 226A uses information in the statement of health 230 and in update information 240 to apply a quarantine enforcement policy. The quarantine enforcement policy may be a predetermined policy established by a network administrator that specifies whether updates identified in update information 240 need to be installed in client 110A as a condition of client 110A receiving access to managed network 120. If other SHVs are present, QS 211 aggregates information from SHV 226A and other SHVs, such as SHV 226B and 226C, to determine whether client 110A satisfies all aspects of the quarantine enforcement policy. Thereafter, QS 211 sends a statement of health response 232 to QC 210, indicating whether access is granted or denied.

Statement of health response 232 may indicate to QC 210 whether access is granted or whether client 110A is quarantined. If client 110A is quarantined, statement of health response 232 may indicate to QC 210 the reasons why client 110A was quarantined. In some embodiments, QC 210 may use this information to supply reasons for the quarantine to a human user of client 110A so that the human user may take remedial steps. For example, in response to an indication that antivirus software in client 110A is out of date, a human user of client 110A may be instructed to update the antivirus software. In other embodiments, QC 210 may pass information concerning the reasons why client 110A is placed in a quarantine state to other components within client 110A that automatically take remedial action. For example, if statement of health response 232 indicates that client 110A has been quarantined because patches to its operating system software have not been applied, QC 210 may pass this information to one of the SHA 216A . . . 216C that manages health information relating to operating system patch status, which may then make a call to update agent 214, triggering update agent 214 to automatically access update server 150 to obtain the required updates.

In some embodiments, update agent 214 may be constructed to allow updates to be performed either manually or automatically in response to information contained within statement of health response 232. In such embodiments, QS 211 may insert into statement of health response 232 codes indicating whether update agent 214 is to perform automatic updates when client 110A is placed in a quarantined state.

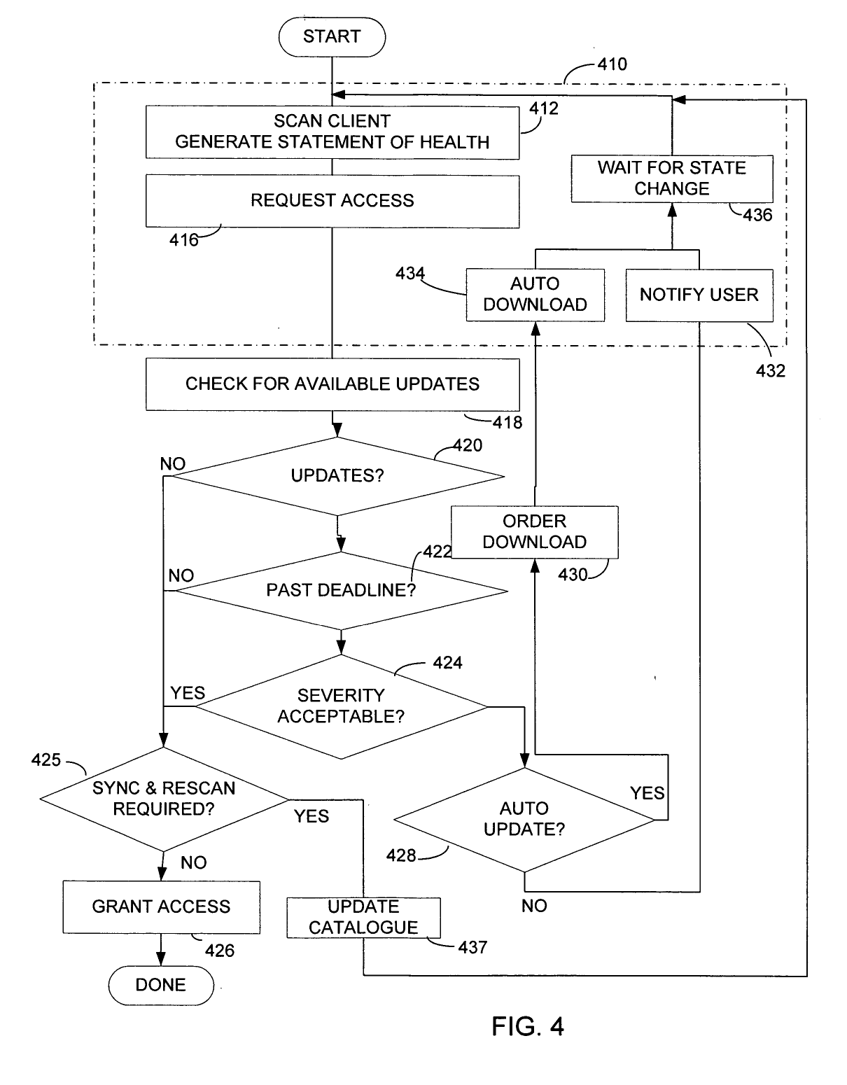

Turning now to FIG. 4, a flow chart of a process by which the software illustrated in FIG. 2 may operate is shown. This flow chart shows the process performed by an SHA and SHV to determine whether or not the client has required patches. Other SHAs and SHVs may use a similar process tailored to the specific scanning and verification steps to determine whether the client complies with other requirements of a policy.

The process shown in FIG. 4 may be executed with software implemented in any suitable way. In the illustrated embodiment, FIG. 4 shows a subprocess 410 executed by software executing within client 110A. Other portions of the process may execute within server 112.

The process begins at block 412. At block 412, SHAs within client 110A scan software within client 110A to determine the status of the software. Though only processing of information on patch status of operating system software is described in detail, a quarantine decision may be made based on any number of types of status information which may be collected by multiple SHAs. Regardless of the number of SHAs present, the information from the SHAs may be aggregated and formulated as a statement of health by QC 210.

At block 416, client 110A generates a request for access to managed network 120. The request for access may be made in any suitable format by any suitable component. For example, the request may be made in the format conventionally used to request an address from an access server operating under the DHCP protocol. Though pictured as a single request, a request for access may involve an exchange of any number of messages or any number of datagrams according to any suitable protocol. Some portion of the request for access includes a statement of health, which may be in the format of statement of health 230 (FIG. 3).

After the request for access is made, the process proceeds to block 418, where a check for available software updates is made. With the software architecture illustrated in FIG. 2, processing in block 418 is performed by SHV 226A. To enable SHV 226A to perform this check, QS 211 passes the relevant portions of statement of health 230 to SHV 226A. Statement of health 230 may contain an indication that client 110A has not installed all updates. In some embodiments, SHA 216A on client 110A may download a catalogue of available updates from update server 150. SHA 216A compares updates installed on client 110A to those listed in the catalogue. If the catalogue lists a required update that is not installed on client 110A, SHA 216A may generate information for inclusion in statement of health 230 indicating that client 110A is not up-to-date.

At decision block 420, the process branches depending on whether missing updates are available. If no such updates are available, the process proceeds to decision block 425. At decision block 425, a determination is made whether the catalogue used by SHA 216A was up-to-date when a scan of the client was made at block 412. In the embodiment illustrated in FIG. 3, SHV 226A may download from update server 150, an indication of when a catalogue applicable to client 110A was last made available.

If the catalogue used by SHA 216A was not up-to-date, processing may proceed to block 437. At block 437, client 110A “synchronizes” with the update server by downloading an updated catalogue. Processing may then proceed to block 412 where the updated catalogue is used in rescanning client 110A and repeating the process of requesting access.

Alternatively, if the catalogue used by client 110A was up-to-date, processing proceeds to block 426 where client 110A is granted access to managed network 120. In the described embodiment, a QS 211 “grants” access by signifying that client 110A should not be quarantined. Though, access may ultimately be granted through an exchange of messages in any suitable format. Other portions of server 112A, operating as a conventional access control server, may actually control the provision of access to the network. In some embodiments, access is granted using messages such as are transmitted by a DHCP server in a conventional computer system.

FIG. 4 shows an embodiment in which the decision to grant access to client 110A is based on the status of available patches for software in client 110A. Such an embodiment is shown for simplicity. In some embodiments, multiple criteria will be used to determine whether client 110A should be granted access. Where multiple criteria are used, access is granted at block 426 only when all criteria of the access control policy implemented by server 112A are met.

If, as determined at decision block 420, an update is available, processing proceeds from decision block 420 to decision block 422. Beginning at decision block 422, SHV 226 applies policy rules to the update to determine whether client 110A should be quarantined because it does not include that update. In the illustrated embodiment, two policy rules are applied to determine whether the missing update warrants a decision that the client should be quarantined. Only two such rules are shown for simplicity, though any number of rules may be specified in a policy and may therefore be used to make a decision whether to grant access.

At decision block 422, a first of the two policy rules is applied. The rule applied at decision block 422 relates to the time at which an update becomes “mandatory.” In the embodiment illustrated, each patch is assigned a deadline by which it must be installed. Before the deadline is reached for a patch, a client is not quarantined because it is missing that patch.

The deadline for each patch may be specified in any suitable way. Each update may have its own deadline. In such an embodiment, update information 240 may indicate the deadline by which a client must install the patch or be quarantined. Alternatively, each client may be given a “grace period” in which to install a patch. In such an embodiment, update information 240 may specify the time at which a patch became available and SHV 226A may determine the deadline for that patch by adding a grace period to the time at which the patch became available.

As an example, a policy may be implemented in which each patch is required to be installed within twenty-two hours of being available. Providing such a “grace period” allows each client computer connecting to managed network 120 one day after the patch is available to download the patch. At some point during that day, the client may connect to update server 150 as the client goes through its daily operating cycle. This way, downloads from update server 150 for all the clients in the network may be spread out over an entire day. If each client were required to download a patch as soon as the patch became available, significant loading could be placed on update server 150 as users of clients within network 120 report for work and attempt to connect their workstations to managed network 120.

Regardless of the specific manner in which the deadline is established, if there are no patches for which the deadline has passed, processing proceeds to decision block 425. Processing at decision block 425 is described above and may result in block 426 being performed, causing access to be granted as described above.

Alternatively, if a patch is available and the deadline for installation of that patch has passed, processing proceeds to decision block 424 where a second policy rule is applied. In this example, the second policy rule relates to the severity attached to the patch. As is known in the art, software patches often address different types of issues. Some updates address security vulnerabilities, while other patches correct minor bugs in the software. Yet other patches may serve to add features or otherwise perform nonessential upgrades. Accordingly, patches may be classified by severity level, with patches addressing security concerns being classified with a higher severity than those addressing minor bugs or adding features.

The policy implemented by QS 211 may specify a severity level of patches that must be installed in client 110A for client 110A to be given access to managed network 120. Conversely, the policy may specify severity levels of patches that are non-essential. Regardless of the manner in which severity is specified in the quarantine enforcement policy, if the only patches identified at block 418 have a severity level that is acceptable according to the policy, access may be granted without requiring client 110A to update. Accordingly, if the severity level of available patches that have not been installed is acceptable, the process continues to decision block 425. Processing at decision block 425 is described above and may result in block 426 being performed, where access is granted. Alternatively, if the severity level of patches not installed in client 110A is not acceptable, processing proceeds to decision block 428 where the process of quarantining and remediating the client begins.

When, as determined at decision block 424, a patch is available for which the deadline has passed and the severity category attached to the patch is high enough that the quarantine enforcement policy is violated if the patch is not installed, the process continues to decision block 428. At decision block 428, the process branches depending on whether the computer system executing the process has been configured for automatic updates.

In some embodiments, a network administrator may specify that out-of-date clients automatically download patches to remediate. If automatic updates are enabled, the process continues to block 430 where QS 211 provides a statement of health response 232 indicating that updates are required. Any suitable format may be used within statement of health response 232 to signify that QC 210 should download updates.

Processing then proceeds to block 434. At block 434, QC 210 may provide information from the statement of health response 230 to an appropriate SHA, which may access update agent 214. Update agent 214 may contact update server 150 to obtain updates needed to bring client 110A into compliance with a quarantine enforcement policy administered by access server 112A. The specific updates required may be identified by update server 150 or may be identified in the statement of health response sent by server 112A. Update agent 214 may, as in a conventional update agent, download and install the required updates.

Processing then proceeds to block 436. At block 436, client computer 110A waits for a change in its update state. Merely downloading the patches may not complete the remediation process. Software may need to be installed and reconfigured or the client computer may need to be rebooted following the update for the update to become effective. A change in the update state of client 110A may be determined by an SHA monitoring the status of installed patches.

Any suitable means may be used to cause the process to wait until updates are installed. In fact, no separate wait state need be encoded to correspond to block 436. As described above, QS 211 may deny access to client 110A until updates required by the quarantine enforcement policy are successfully implemented. Therefore, even if the process continues before the updates are made, client 110A will be forced to wait to receive access to managed network 120. Nonetheless, incorporating process block 436 to wait for a state change may be desirable in some embodiments to reduce the number of requests for access generated by client 110A.

Alternatively, if automatic updates have not been enabled by a network administrator, processing proceeds from decision block 428 to process block 432. At process block 432, QS 211 generates a statement of health response 232 that may simply indicate client 110A is quarantined. Upon receipt of such a response, QC 210 may notify a user of client 110A that updates are needed to remove client 110A from quarantine. As is conventional, update agent 214 may receive user input directing update agent 214 to connect to update server 150 and download required updates.

Once the user is notified at process block 432, the process proceeds to block 436, where client 110A waits for a change in the update state of client 110A. As described above, an SHA may monitor the status of patches installed in the operating system of client 110A and may allow the process shown in FIG. 4 to proceed once a change in the status of installed patches is detected. Regardless of how processing arrives at block 436, once a change in status of patches installed in client 110A is detected, processing continues to block 412.

When processing returns to block 412, client 110 has been updated and should comply with the quarantine enforcement policy of managed network 120. If client 110A has been updated to comply with the quarantine enforcement policy of managed network 120, the process should proceed to block 426 when client 110A is granted access to managed network 120. Alternatively, if the updates performed on client 110A do not bring the client into compliance with the quarantine enforcement policy, the process will again proceed to decision block 428 where the need for either automatic or manual updating is communicated to client 110A. The process may continue in this fashion until client 110A is “remediated” to bring it into compliance with the quarantine enforcement policy of managed network 120.

FIG. 4 illustrates operation of a network in accordance with aspects of a specific quarantine enforcement policy. Various aspects of a quarantine enforcement policy may be specified by a network administrator. For example, a managed network may be configured so that quarantined clients automatically download missing updates. Or, the policy may specify that a quarantined client is to simply notify its user that an update is required or that the client is to prompt the user to install the missing update. Other elements of the quarantine enforcement policy, such as the severity level of patches required to be installed, may also specified by the network administrator.

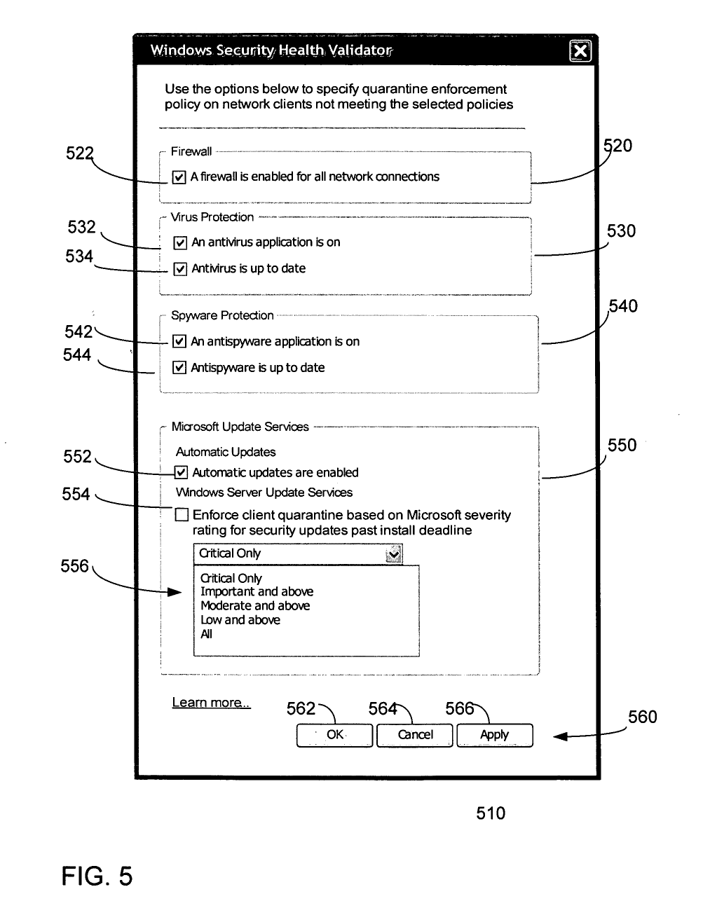

In a managed network, the quarantine enforcement policy may be specified by a network administrator providing inputs to access server, such as server 112A. FIG. 5 is an example of a user interface that may be presented to a network administrator through a user interface device 113 of server 112A. Graphical user interface 510 may be used by a network administrator to specify all or a portion of a quarantine enforcement policy for managed network 120.

In the illustrated embodiment, graphical user interface 510 is arranged with multiple display areas, each corresponding to specific type of protective software that may be installed on a client. Display area 520 corresponds to firewall software. Display area 520 includes a control 522 in the form of a check box or other suitable control. Control 522 may be implemented in a conventional fashion and may be activated by a user manipulating a mouse or other pointing device that is part of user interface device 113. In the embodiment pictured in FIG. 5, control 522 is shown with a check mark indicating that the network administrator requires a firewall to be enabled for all network connections made by a client seeking access to managed network 120.

Graphical user interface 510 also includes a display area 530 relating to virus protection software. In the example illustrated, a network administrator may specify two attributes of virus protection software as an element of a quarantine enforcement policy. Each attribute is specified through a control in display area 530. Each control in this example is also implemented as a check box. When control 532 is checked, the quarantine enforcement policy requires a client seeking access to managed network 120 to have antivirus protection software running. When the control 534 is checked, the quarantine enforcement policy requires that the antivirus software on the client be up-to-date.

Graphical user interface 510 also includes a display area 540 relating to spyware protection software. In this example, the display area 540 includes controls 542 and 544 applicable to spyware protection software. As with controls 532 and 534, each of controls 542 and 544 may be implemented as a conventional checkbox. When the checkbox associated with control 542 is checked by the network administrator, a client must have spyware protection software running in order to be granted access to the managed network 120. When the checkbox associated with control 544 is checked, the client requesting access must have up-to-date spyware protection software in order to be granted access to managed network 120.

Graphical user interface 510 also includes display area 550 associated with software patches. Display area 550 includes controls with which a network administrator may specify the severity level of patches that must be installed for a client to comply with the quarantine enforcement policy. In the example illustrated, display area 550 also includes control 552 to specify a remediation strategy. When the checkbox associated with control 552 is checked, automatic updating is enabled. To relate this control to the processing illustrated in FIG. 4, processing proceeds from decision block 422 to process blocks 430 and 434 when control 552 is checked. Conversely, when the checkbox associated with control 552 is not checked, processing proceeds from decision block 428 to process block 432.

Also as illustrated in FIG. 4, a quarantine enforcement policy may include a determination of whether updates that are missing from a client requesting access to a managed network are severe enough to warrant remediation or quarantine. As shown in FIG. 4, decision block 424 compares the severity of missing updates to a severity level specified as part of the quarantine enforcement policy. Control 554 and drop down list box 556 allow a network administrator to specify this element of the quarantine enforcement policy.

Control 554 may be implemented as a conventional checkbox. When the checkbox associated with control 554 is checked, SHV 226A will perform the processing as indicated by decision block 424 in FIG. 4 to determine whether missing updates are severe enough to warrant quarantine or remediation. An acceptable level of severity may be specified through drop down list box 556.

In the embodiment illustrated in FIG. 5, patches for software are provided by the software vendor. The vendor classifies patches based on severity. In the example illustrated, patches may be classified as “critical,” “important,” “moderate” or “low.” As shown in the example of FIG. 5, drop down list box 556 lists severity levels that may be specified by a network administrator. For example, the network administrator may specify that a client be quarantined for missing updates to software only if the missing updates have been classified as critical. Alternatively, the network administrator may choose other entries from list box 556 specifying that a client be quarantined if it is missing updates of other severities. In further alternative embodiments, a network administrator may specify updates that are required based on other categories, such as a category of application to which the update applies.

Being able to specify required updates by category simplifies the specification and maintenance of a quarantine enforcement policy. A network administrator does not need to know which updates are available or even what each update does. Rather, the network administrator can rely on severity categories assigned by the patch supplier.

Graphical user interface 510 may include different or additional controls to specify elements of a quarantine enforcement policy. For example, a drop down list box is useful for specifying a severity from a list of enumerated choices. If severities of updates are specified in other ways, other forms of control may be used.

Alternatively, elements of the quarantine enforcement policy may be specified by default or may be entered by a network administrator in other ways. For example, in the process of FIG. 4, a deadline for installing patches is checked at decision block 422 before quarantining a client based on missing patch information. Graphical user interface 510 may in some embodiments be augmented with controls to collect deadline or other information concerning a quarantine enforcement policy.

Graphical user interface 510 may also include other controls to aid a network administrator specify a quarantine enforcement policy. For example, control area 560 includes controls such as controls 562, 564 and 566 to close graphical user interface 510 and apply the settings specified through graphical user interface 510, or to cancel any input modifying the quarantine enforcement policy or to apply the settings without closing the graphical user interface, respectively. When either control 562 or control 566 is activated by the user, data reflecting inputs made through graphical user interface 510 is passed to the appropriate SHV on server 112A. For example, an SHV may be available for firewall software, virus protection software, spyware protection software, and update services software. The inputs specified corresponding to each type of protective software may then be passed the appropriate SHV.

The types of display areas pictured in FIG. 5 are examples. As described above, client 110A may include a system heath agent that is capable of determining the operating state of any component of protective software or other indicator of health. This status information may be included in the statement of health 230 communicated to access server 112A as part of a request for access. A corresponding SHV installed in access server 112A may process this status information. The SHV may receive inputs specified in a corresponding display area of graphical user interface 510 that define the operating state that comply with the quarantine required operating states enforcement policy. In this way, a network administrator may simply specify aspects of a quarantine enforcement policy.

Having thus described several aspects of at least one embodiment of this invention, it is to be appreciated that various alterations, modifications, and improvements will readily occur to those skilled in the art.

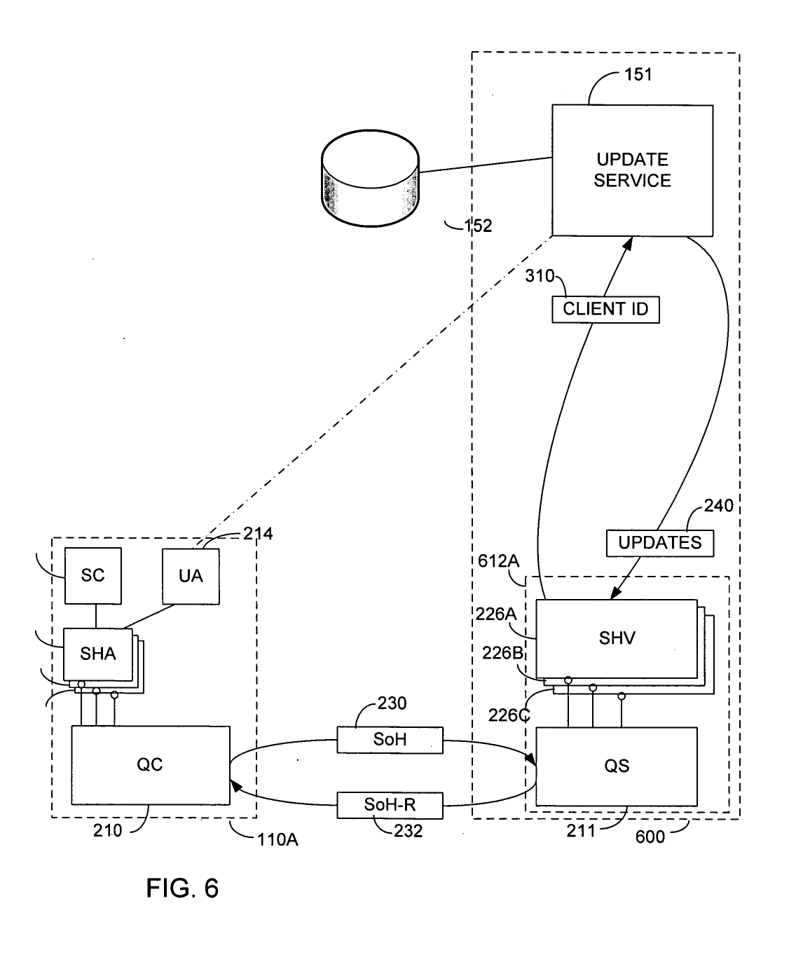

FIG. 6 shows one alternative software architecture for computer system 100. It is not necessary that each of the services depicted operate on physically separate computers. In the embodiment shown in FIG. 6, update service 151 is shown operating on a physical computer 600. The functions performed by access server 112A (FIG. 2) may be performed by a service 612A, also executing on computer 600.

More generally, any service described herein may be implemented on any suitable computer. As another example, FIG. 2 shows an access control service and a quarantine service being implemented on a single computer such as servers 112A and 112B. It is not necessary that the quarantine service and an access service be implemented on the same physical computer. As shown in FIG. 1, some clients, such as client 110C and 110D, do not connect to network 122 through an access server at all. In embodiments in which no access server is present, quarantine service will not be implemented in the access server. Further, the quarantine service may be implemented separately from the access control service whether or not an access server is present. Separate implementation may facilitate provisioning of the network or may be desirable for other reasons.

For example, a single update server is shown. Any number of update servers may be available. Further, it is not necessary that the update server be outside the managed network. In networks in which a client may be given access to the managed network with to the network for limited purposes, the client may be allowed access to an update server to access updates, but be denied access for other purposes.

Additionally, it is not necessary that the update server be managed by the network administrator of the managed network. In managed networks for large enterprises, a network administrator may provide an update server. In small companies, or in other situations in which a network administrator does not have the desire or ability to manage an update server, the update server may be provided by a software vendor or third party update service and may be accessed through Internet 130 (FIG. 1) rather than being connected directly to WAN 122. In this case, the ability for a network administrator to specify a quarantine enforcement policy based on predetermined categories of updates is particularly useful because the network administrator may not be aware of the updates available on the update server.

Further, it is described that patches are categorized as “critical,” “important,” “moderate” and “low.” Any suitable designation may be used. In the embodiment illustrated, each update is given a category from an enumerated set of categories. Using an enumerated set facilitates specifying a quarantine enforcement policy for any patch. Also, using an ordered set facilitates specifying a quarantine enforcement policy because quarantine decisions may be specified to be applicable to patches that have a severity above some threshold level. However, any suitable method of specifying severity and how to make a quarantine decision for each specified severity may be used.

Also, information is described to be “sent” or “received.” Such terms may indicate the origin or destination of information that is transferred, but do not indicate how the transfer was initiated. For example, the transfer may be a “push” or a “pull” transfer, with the transfer initiated by either the source or the destination of the transfer.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a computer system having a client, a first service and a second service, the method comprising:
a) receiving with the first service a request for network access from the client;
b) in response to the request for network access, sending a request for status from the first service to the second service, the request for status identifying the client;
c) receiving at the first service information about the status of the client from the second service; and
d) making a determination relating to network access for the client, the determination being based at least in part on the received information about the status.

2. The method of operating a computer system of claim 1, wherein the second service executes on an update server and the method further comprises:
e) sending a software update from the update second server to the client.

3. The method of claim 2, wherein sending a software update comprises sending the software update prior to receiving the request for network access.

4. The method of claim 2, wherein the information about the status of the client comprises information about the software update status of the client and wherein sending the software update comprises sending the software update after making a determination relating to network access and wherein the method further comprises:
f) granting network access to the client after sending the software update.

5. The method of claim 2, wherein receiving a request for network access comprises receiving an identifier of the update server.

6. The method of claim 1, wherein receiving a request for network access comprises receiving an indication of the time at which the client last downloaded a catalogue of available software updates.

7. The method of claim 1, further comprising generating a statement of health by taking actions comprising scanning the client to determine whether it includes software operating according to a predetermined policy.

8. The method of claim 7, wherein receiving a request for network access comprises receiving the statement of health.

9. A method of operating a computer system having a client and a server, the method comprising:
a) sending a request for network access from the client to the server;
b) in response to the request for access, identifying a category of software update available but not installed on the client, the category of software update being one of an enumerated set of software update classifications; and
c) making a determination relating to network access for the client based on the category of the software update.

10. The method of claim 9, wherein the enumerated set comprises: critical, important, moderate and low.

11. The method of claim 9, wherein the computer system further comprises a second server and identifying the category of software update comprises receiving an indication of the category at the server from the second server.

12. The method of claim 11, wherein making a determination is performed by the server.

13. The method of claim 9, wherein:
i) the method further comprises executing an agent on the client to obtain an indication of operational status of the client; and
ii) sending a request for network access comprises communicating the indication of operational status of the client to the server.

14. The method of claim 13, wherein identifying a category of software update comprises receiving at the server information on software updates available to the client separate from the indication of operational status of the client.

15. The method of claim 9, further comprising establishing a policy according to a method of establishing a policy comprising:
i) displaying a user interface including a list of severity ratings; and
ii) receiving through the user interface user input specifying a severity rating in the list of the severity ratings; and
wherein making a determination comprises determining that the category of the software update matches the severity rating specified in the user input.

16. The method of claim 15, wherein the method of establishing a policy further comprises receiving through the user interface policy attributes concerning at least one of antivirus protection, a firewall and spyware protection.

17. A method of operating a computer system having a client, a first service and a second service, the method comprising:
a) receiving with the first service a request for network access from the client, the request for network access including a first time value indicative of the time at which the client was updated;
b) receiving with the first service information from the second service a second time value indicating when an update for the client was available; and
c) making a determination relating to network access for the client based at least in part on the first time value and second time value.

18. The method of claim 17, wherein making a determination comprises comparing the difference between the first time and the second time to a predetermined policy.

19. The method of claim 18, further comprising:
d) in response to the determination relating to network access, obtaining an update for the client; and
e) repeating a), b) and c) following d).

20. The method of claim 19, wherein receiving with the first service a request for network access from the client, comprises receiving a request for network access including a first time value indicative of the time at which the client obtained a catalogue of available updates.
